(19) United States
(12) Patent Application Publication
(10) Pub. No.: US 2021/0187372 A1
(43) Pub. Date: Jun. 24, 2021

(54) SYSTEM AND METHOD FOR SPORTS IMPLEMENT TUNING

(71) Applicant: I/P SOLUTIONS, INC., PERRYSBURG, OH (US)

(72) Inventor: THEODORE J. STECHSCHULTE, MAUMEE, OH (US)

(73) Assignee: I/P SOLUTIONS, INC., PERRYSBURG, OH (US)

(21) Appl. No.: 16/071,198

(22) PCT Filed: Jan. 19, 2017
(86) PCT No.: PCT/US2017/014048

§ 371 Date: Jul. 19, 2018

Related U.S. Application Data
(60) Provisional application No. 62/281,239, filed on Jan. 21, 2016.

(51) Int. Cl. A63B 60/42; A63B 60/46

(52) U.S. Cl. CPC A63B 60/42; A63B 2102/32; A63B 60/46

(57) ABSTRACT

A system and method for adjusting a sport implement or a set of sports implements based on information collected from sports simulation equipment is provided. The system comprises an analysis engine in communication with a data input source; and a storage device in communication with the analysis engine. In response to receiving information relating to a shape of the sports implement, the analysis engine accesses the storage device to facilitate an analysis of the shape of the sports implement. The analysis engine generates information relating to a tuning process which may be performed based on the shape of the sports implement and information on the storage device.

### CLAIM OF PRIORITY

The present application claims the benefit of priority to U.S. Provisional Application No. 62/281,239 filed on Jan. 21, 2016, which is incorporated herein in its entirety by reference.

### FIELD OF THE INVENTION

The invention relates to sports simulation equipment and, more particularly, to a system and method for tuning at least one sports implement based on information collected from the sports simulation equipment.

### BACKGROUND OF THE INVENTION

Sports simulation environments are well-known and are often used to provide a training experience which can provide a user with information relating to a user's performance typically not available to the user during ordinary participation in a sport. For example, a sports simulation environment may be used to simulate the experience of playing the game of golf without requiring a large area ordinarily necessary when a user participates in the sport. Such simulated play often results in sports simulation equipment providing feedback to a user relating to their performance inside the sports simulation environment, which allows the user to refine a technique used in the sport, with a goal of improving a performance of the user during ordinary participation in the sport. Equipment used with the sports simulation environment may include an object tracking device for detecting a changing position of an object traveling within the sports simulation environment (as a non-limiting example, the object may be a golf ball), and a processor for receiving a signal from at least one sensor. The processor analyzes the signal from the object tracking device and the sensor and generates an image signal in response to the analysis of the signal from the object tracking device and the sensor, wherein the analyzing of the signal from the sensor includes determining a relationship of the object struck by the user in relation to a simulated environment (as a non-limiting example, the simulated environment may be a golf course or a practice range).

Sports simulation environments also afford the opportunity to record other data that may be analyzed. Recording may be performed by one or more of a number of types of sensors, which may be in communication with the sports simulation environment. Recording the technique of the user and movement and position of a sports implement may facilitate enhanced analysis that could provide valuable feedback to be used for tuning a sports implement.

Traditionally, the process of tuning a sports implement is known as “fitting.” Fitting may be recommended as manufacturing tolerances for sports implements vary greatly, which often results in even custom fitted sports implements having wide ranging tolerances. Further, use of the sports implement may result in changes to its shape, wherein the fitting process is recommended to tune the sports implement. A fitter, who typically has extensive knowledge about the tuning process, may gather performance information by observing a tuning candidate playing a sport or by using the sports simulation equipment. Further, the fitter may analyze at least one sports implement of the tuning participant to determine if the at least one sports implement analyzed should be adjusted. As anon-limiting example, the fitter may recommend adjusting a lie and loft of at least one of the sports implements of the tuning candidate to improve a performance of the tuning candidate when the at least one sports implement following adjustment by the fitter. Lastly, the fitter may make recommendations to the tuning candidate about techniques the tuning candidate employs and may adjust the at least one sports implement of the tuning candidate to meet the needs of the tuning candidate. Typically, recommendations by the fitter regarding techniques the tuning candidate employs requires training on part of the tuning candidate in order to adapt their techniques to the techniques recommended by the fitter.

It would be advantageous to develop a system and method for adjusting at least one sports implement based on information collected from the sports simulation equipment that facilitates a tuning process where sports implement tuning incorporates a technique of a tuning candidate.

### SUMMARY OF THE INVENTION

Presently provided by the invention, a system and method for adjusting at least one sports implement based on information collected from the sports simulation equipment that facilitates a tuning process where sports implement tuning incorporates a technique of a tuning candidate, has surprisingly been discovered.

In one embodiment, the present invention is directed to a sports implement tuning system. The sports implement tuning system comprises an analysis engine and a storage device. The analysis engine is in communication with a data input source. The storage device is in communication with the analysis engine. In response to receiving information relating to a shape of the sports implement, the analysis engine accesses the storage device to facilitate an analysis of the shape of the sports implement. The analysis engine generates information relating to a tuning process which may be performed based on the shape of the sports implement and information on the storage device.

In another embodiment, the present invention is directed to a tuning system for a set of sports implements. The tuning system comprises an analysis engine and a storage device. The analysis engine is in communication with a data input source. The storage device is in communication with the analysis engine. In response to receiving information relating to a shape of each of the sports implements of the set of sports implements and at least one use instance for each of the sports implements of the set of sports implements, the analysis engine accesses the storage device to facilitate an analysis of the information relating to a shape of each of the sports implements of the set of sports implements and the at least one use instance for each of the sports implements of the set of sports implements. The analysis engine generates information relating to a tuning process which may be performed on each of the sports implements of the set of sports implements based on the information relating to the shape of each of the sports implements of the set of sports implements, the at least one use instance for each of the sports implements of the set of sports implements, information on the storage device, and statistical anomalies in the collected use instance distribution data.

In yet another embodiment, the present invention is directed to a method for tuning a sports implement. The method comprises the steps of providing an analysis engine in communication with a data input source, providing a storage device in communication with the analysis engine, receiving information relating to a shape of the sports implement at the analysis engine from the data input source, accessing the storage device to facilitate an analysis of the information relating to the shape of the sports implement using the analysis engine, and generating information using the analysis relating to a tuning process which may be performed based on the information relating to the shape of the sports implement and information on the storage device.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a schematic illustration of sports implement tuning system in communication with an arrangement of sports simulation equipment;

FIG. 2 is a schematic illustration of the sports implement tuning system shown in FIG. 1, the sports implement tuning system including an analysis engine and a storage device;

FIG. 3A illustrates a lie angle and a loft angle of an exemplary sports implement;

FIG. 3B illustrates the exemplary sports implement in a dynamic state;

FIG. 4 is a schematic illustration of the process used to generate a tuning report used with a set of sports implements;

FIG. 5 is a schematic illustration of a process by which the fitter uses the sports implement tuning system 10 to collect data for each of the sports implements;

FIG. 6 is a schematic illustration of a process by which the analysis engine 16 reviews collected shot data for the sports implement;

FIG. 7 is a schematic illustration of a process by which the sports implement tuning system utilizes the flight physics engine to makes recommendations for modifications to a lie and loft of the sports implement; and

FIG. 8 is a schematic illustration of a process by which the lie and loft of the sports implement is adjusted using either a manually operated system or an automatically operated system.

### DETAILED DESCRIPTION OF THE PREFERRED EMBODIMENTS

It is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined herein. Hence, specific dimensions, directions or other physical characteristics relating to the embodiments disclosed are not to be considered as limiting, unless expressly stated otherwise.

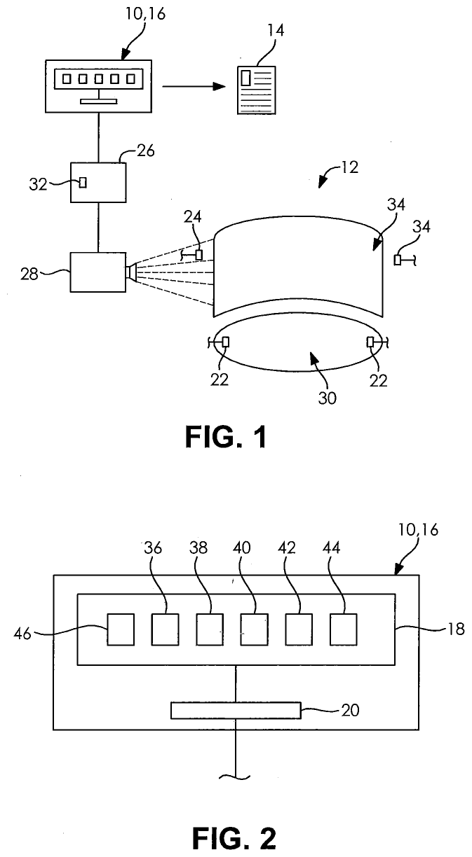

FIG. 1 illustrates a sports implement tuning system 10 and an arrangement of sports simulation equipment 12. The sports implement tuning system 10 is in communication with the sports simulation equipment 12; however, it is understood that the sports implement tuning system 10 may form a portion of the sports simulation equipment 12 or that the sports implement tuning system 10 may incorporate features of the sports simulation equipment 12 to allow the sports implement tuning system 10 to operate in a standalone manner. In response to a user of the sports simulation equipment 12 directing the sports implement tuning system 10 to analyze data collected by the sports simulation equipment 12, the sports implement tuning system 10 generates a tuning report 14. The tuning report 14 facilitates a sports implement tuning process, which may be performed manually or automatically, wherein at least one sports implement of a tuning candidate is tuned.

FIGS. 1 and 2 illustrate the sports implement tuning system 10. The sports implement tuning system 10 is in communication with the sports simulation equipment 12, or as mentioned above, the sports implement tuning system 10 may form a portion of the sports simulation equipment 12 or may be operated in a standalone manner. The sports implement tuning system 10 comprises at least an analysis engine 16 and a storage device 18. The sports implement tuning system 10 may be in communication with the sports simulation equipment 12 via a data interface 20. The analysis engine 16 is in data communication with the data interface 20 (when present) and the storage device 18. Upon receipt of data from the sports simulation equipment 12 or a plurality of inputs in communication with the analysis engine 16, the analysis engine 16 generates the tuning report 14. It is understood that in embodiments of the invention not shown that the analysis engine 16 and a storage device 18 may be used by the sports simulation equipment 12 for performing a plurality of tasks. In embodiments of the invention where the sports implement tuning system 10 forms a portion of the sports simulation equipment 12, it is understood that the data interface 20 may not be required. In embodiments of the invention where the sports implement tuning system 10 operates in a standalone manner, it is understood that the sports implement tuning system 10 may incorporate any of the features of the sports simulation equipment 12 described herein.

FIG. 1 illustrates the sports simulation equipment 12. The sports simulation equipment 12 comprises a plurality of user tracking devices 22, a plurality of object tracking devices 24, a processor 26, and a projector 28. The plurality of user tracking devices 22, the plurality of object tracking devices 24, and the projector 28 are in communication with the processor 26. It is understood that any number of user tracking devices, object tracking devices, projectors, and processors may be used. It is further understood that any specific positioning of the user tracking devices 22, the object tracking devices 24, the projector 28 and other equipment is not limited by the arrangement illustrated in FIG. 1. Other configurations and relative positioning can be used. As a non-limiting example, the sports simulation equipment 12 may be commonly referred to as a sports simulator. As a further non-limiting example, the sports simulation equipment 12 may be a golf simulator.

Each of the user tracking devices 22 is a tracking camera in communication with the processor 26. The user tracking devices 22 are positioned such that a collective field of view of the user tracking devices 22 covers a pre-defined field of activity 30 where user activity generally occurs. However, it is understood that any other means of tracking a position of the user may be used, such as an accelerometer/gyroscopic system, a transponder system, a sonic/sonar system, and structured light/machine vision techniques known in the art, such as marked attire (e.g. light emitting diode markers) or projected grid or line patterns, for example. In certain embodiments, the user may wear an object such as a hat with one or more markers (e.g. dots, lines, or other shapes or patterns). As such, the markers are detected by the user tracking devices 22 as the user enters the field of activity 30 and tracked as the user moves within a field of vision of the user tracking devices 22.

The object tracking devices 24 are positioned to track a motion of any object, such as, but not limited to sports implements used in the game of golf. Non-limiting examples of sports implements that can be tracked by the object tracking devices 24 are a golf club, a cricket bat, a hockey stick, a javelin, and any sports projectiles that may be associated with such implements. Further, it is understood that the sports implement may be a portion of the user, such as but not limited to, a foot or a hand of the user, and that when the sports implement is a portion of the user, that such sports implement may include an article covering the foot or the hand of the user, such as but not limited to, a shoe or a glove. The object tracking devices 24 are typically high speed cameras for tracking at least a speed, a direction, a spin of a moving object, in addition to other characteristics of the moving object. As a non-limiting example of the object tracking device 24, the object tracking device 24 may be the 3Trak® launch monitor used in simulators manufactured by aboutGolf Ltd. of Maumee, Ohio. However, it is understood that other object tracking devices can be used, as appreciated by one skilled in the art.

The processor 26 is in data communication with the user tracking devices 22 for receiving a sensor signal therefrom, analyzing the sensor signal, and generating the image signal in response to the analysis of the sensor signal. As a non-limiting example, the processor 26 analyzes the sensor signal based upon an instruction set 32. The instruction set 32, which may be embodied within any computer readable medium, includes processor executable instructions for configuring the processor 26 to perform a variety of tasks and calculations. As a non-limiting example the instruction set 32 includes processor executable algorithms and commands relating to image processing, spatial representation, geometrical analysis, three-dimensional physics, and a rendering of digital graphics. It is understood that any equations can be used to model the position of at least a portion of the user, it is further understood that the processor 26 may execute a variety of functions such as controlling various settings of the user tracking devices 22, the object tracking devices 24, and the projector 28, for example, in certain embodiments, the processor 26 includes a software suite for tracking a movement and trajectory of an object in the field of activity 30.

The projector 28 is positioned to project an image onto a display screen 34. It is understood that a plurality of projectors may be used to provide a panoramic or a surrounding image. The projector 28 is adapted to receive an image signal from the processor 26 to create and modify the image projected on the display screen 34. It is understood that other displays can be used to generate an image based upon the image signal. In embodiments of the invention not shown, it is understood that the projector 28 and the display screen 34 may be replaced by a backlit style display.

The display screen 34 is positioned to receive an image from the projector 28. The display screen 34 is typically formed from a substantially smooth material and positioned to create a substantially flat resilient surface for withstanding an impact and absorbing the energy of a projectile object; however, it is understood that a plurality of the projectors 24 may be used to provide a panoramic or a surrounding image.

The sports implement tuning system 10 includes the analysis engine 16. The analysis engine 16 executes a series of instructions in response to data received from a data input source. As a non-limiting example, the data input source may be the sports simulation equipment 12 or any portion thereof. In response to the data received from the sports simulation equipment 12, the analysis engine 16 may access information on the storage device 18, change information on the storage device 18, transmit information to the sport simulation equipment 12, and generate the tuning report 14. It is understood that a series of instructions executed by the analysis engine 16 may be stored on a chip forming a portion of the analysis engine 16, may be stored on the storage device 18, or may be stored on both the analysis engine 16 and the storage device 18. It is also understood that the analysis engine 16 may be in data communication with a remote computing device (not shown) or remote storage device (not shown) via a local network, the internet, or another network. Further, in embodiments of the invention not shown, the analysis engine 16 may be in communication with a user input source (not shown), which also forms a portion of the sports implement tuning system 10.

The storage device 18 is in communication with the analysis engine 16. The storage device 18 may be a hard drive, a flash memory chip, or another form of computer memory. As mentioned hereinabove, the analysis engine 16 may access information on the storage device 18 or change information on the storage device 18. Information stored on the storage device 18 may include a series of instructions 36 to be executed by the analysis engine 16, user information 38 about a user of the sport simulation equipment 12, sports implement information 40 specific to the user of the sport simulation equipment 12, biomechanical information 42 about the user of the sport simulation equipment 12, reference information 44 used by the analysis engine 16 to execute the series of instructions 36, and use instance information 46 collected by the object tracking devices 24.

The data interface 20 is a portion of the sports implement tuning system 10 that facilitates data communication between the sports simulation equipment 12 and the analysis engine 16. In one embodiment of the invention, the data interface 20 is configured to accept a data transmission from the sports simulation equipment 12 including information used to form and supplement the user information 38, the sports implement information 40, and the biomechanical information 42. The signal from the sports simulation equipment 12 is a digital signal, and may relay additional information regarding an operational condition of the sports simulation equipment 12 to the analysis engine 16.

The user information 38 about a user of the sport simulation equipment 12 contains identifying data about the user. The user information 38 may be entered into the sports implement tuning system 10 or the sports simulation equipment 12, collected by the sports implement tuning system 10 or the sports simulation equipment 12, or retrieved from a source in communication with the sports implement tuning system 10 or the sports simulation equipment 12.

The sports implement information 40 specific to the user of the sport simulation equipment 12 contains information pertaining to a sports implement or a plurality of sports implements corresponding to a set of sports implements (not shown) of the user. As a non-limiting example, the set of sports implements of the user may comprise a set of golf clubs. When the plurality of sports implements corresponds to the set of sports implements, it is understood that user may select such implements of the set based on a desired outcome of the user. A portion of the sports implement information 40 may be entered into the sports implement tuning system 10 or the sports simulation equipment 12 and a remaining portion may be collected by the sports implement tuning system 10 or the sports simulation equipment 12. As a non-limiting example, the sports implement tuning system 10 or the sports simulation equipment 12 may collect information from the object tracking devices 24 about a speed, a horizontal angle, a vertical angle, and a horizontal offset of each of the sports implements from the set of sports implements of the user during each use instance of each of the sports implements. The analysis engine 16 uses the sports implement information 40, in addition to other information, to facilitate generation of the tuning report 14 using the series of instructions 36.

The biomechanical information 42 about the user of the sport simulation equipment 12 contains biomechanical data about the user. The biomechanical information 42 may be entered into the sports implement tuning system 10 or the sports simulation equipment 12, collected by the sports implement tuning system 10 or the sports simulation equipment 12, or retrieved from a source in communication with the sports implement tuning system 10 or the sports simulation equipment 12. As a non-limiting example, the sports implement tuning system 10 or the sports simulation equipment 12 may collect information from the user tracking devices 22 about at least one swing (a shot instance) and a stance of the user. Information about a given swing, or shot instance, may be referred to as a use characteristic of the sports implement being used. The analysis engine 16 uses the biomechanical information 42, in addition to other information, to facilitate generation of the tuning report 14 using the series of instructions 36. The biomechanical information 42 may include information about a muscular, a joint, or a skeletal action of the user during use of the sports implement tuning system 10 or the sports simulation equipment 12. It is understood that the biomechanical information 42 may include user-specific biomechanical characteristics, which may be identified by applying scientific principles of mechanical physics to understand movements of the user and use of one or more sports implement by the user.

The reference information 44 used by the analysis engine 16 to execute the series of instructions 36 contains information used by the analysis engine 16 to, facilitate generation of the tuning report 14 using the series of instructions 36. The reference information 44 is for the most part, static information used by the series of instructions 36. The reference information 44 may be updated at periodic intervals to reflect changes or additions to the series of instructions 36. A portion of the reference information 44 may be provided by the sports implement tuning system 10 or the sports simulation equipment 12. A non-limiting example of a portion of the reference information 44 provided by the sports implement tuning system 10 or the sports simulation equipment 12 may be referred to as “hole data,” comprising information such as simulated course and hole information, a simulated wind speed and direction, a handedness of the user, a location in three-dimensional co-ordinates of a tee, and a location in three-dimensional co-ordinates of a target, such as a pin.

The use instance information 46 collected by the object tracking devices 24 is used by the analysis engine 16 to facilitate generation of the tuning report 14 using the series of instructions 36. Further, a portion of the use instance information 46 may be generated by a flight physics engine based on information collected from the object tracking devices 24. It is understood that in response to data collected by the object tracking devices 24, the flight physics engine may calculate a path of a projectile object, analyze such a calculated path, and assess the calculated path to obtain a portion of the use instance information. The sports implement tuning system 10 uses the use instance information 46 to accurately generate distances for each shot or swing recognized as input for the sports implement tuning system 10. The parameters which the use instance information 46 comprises are described herein below.

The use instance information 46 is for the most part, information related to usage of the sports implement tuning system 10 or the sports simulation equipment 12. It is understood that the tuning report 14 may include all or any portion of the use instance information 46, and that the contents of the tuning report 14 may be customized to include any desired portion of the use instance information. As a non-limiting example, the use instance information 46 may be stored in a lookup table; however, it is understood that the use instance information 46 may be stored in any conventional data storage format.

As a non-limiting example, the use instance information 46 may include data generated by the object tracking devices 24 regarding a projectile object, such as a ball, hit by the user during any given use instance of the sports implement tuning system 10 or the sports simulation equipment 12. As a second non-limiting example, the use instance information 46 may include data generated by the object tracking devices 24 regarding a sports implement used by the user or a projectile object shot by the user during any given use instance of the sports implement tuning system 10 or the sports simulation equipment 12. The use instance information 46 may include information related to a speed, a vertical angle, a vertical attack angle, a horizontal angle, a backspin, a sidespin, a rifle spin, a total distance, a carry distance, a ground distance, an offline distance, a draw fade distance, a max height, a max height distance, a carry time, a shot smash factor, a shot time, three-dimensional co-ordinates of a max height location, three-dimensional co-ordinates of a mid-location, three-dimensional co-ordinates of an end location, information about a ball confidence, information about a spin confidence, a green distance, an indication of terrain type, an angle of direction of the object tracking devices 24, an end pin distance, a shot type, a location of a projectile object at a start position, a location of a projectile object at an end position, and an aim location. It is understood that the object tracking devices 24 used with the sports implement tuning system 10 or the sports simulation equipment 12 are capable of detecting a rifle spin of a projectile object.

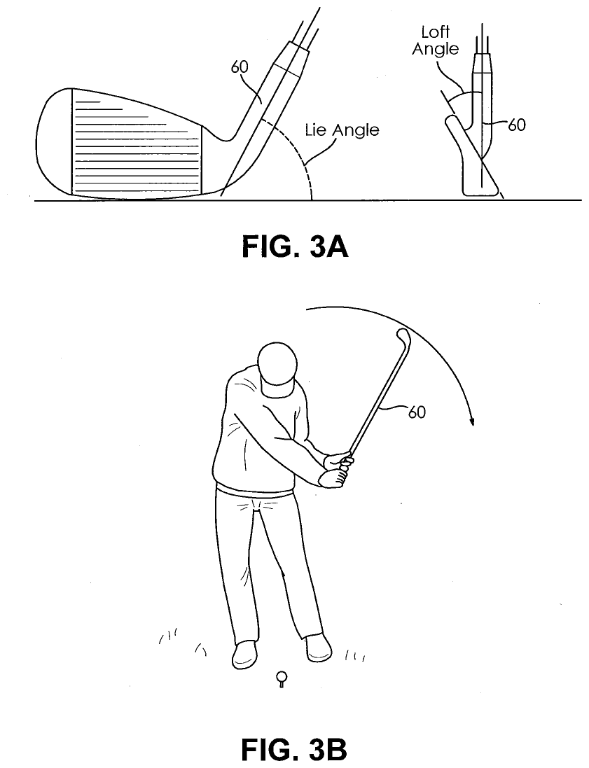

In use, the sports implement tuning system 10 and method for adjusting the sports implement or the plurality of sports implements corresponding to a set of sports implements that facilitates a tuning process where adjustments made to the sports implement or the plurality of sports implements incorporate a technique of the user. The sports implement tuning system 10 and method, through the generation of the tuning report 14, provides recommended changes to the lie and loft angles of the sports implement based on the information collected by the sports implement tuning system 10 or the sports simulation equipment 12 and calculations performed by the analysis engine 16. FIG. 3A illustrates the lie and loft angles of an exemplary sports implement 60. Instead of making a recommendation for changing a swing of the user, the sports implement tuning system 10 and method allows a fitter or an automated fitting machine to tune each of the plurality of sports implements corresponding to a set of sports implements of the user's set to the user's existing swing. When the automated fitting machine is used to tune the set of sports implements, the automated fitting machine is in communication with the sports implement tuning system 10 to implement the recommended changes to the lie and loft angles of each of the sports implements. As a non-limiting example, tuning of each of the sports implements of the user's set may be performed by adjusting a position of a hosel of the sports implement, either by a fitter using a hosel bending bar or the automated fitting machine, which may adjust a position of the hosel in a controlled manner. As a non-limiting example, the automated fitting machine may employ computer controlled hydraulics or pneumatics to adjust a position of a hosel of the sports implement. Tuning of each of the sports implements of the user's set through the adjustment of the lie and loft angles of the sports implement can greatly increase a performance of the user. Minor changes of a position of the face of the sports implement with respect to the projectile object during a shot can create large differences in a resulting hit, especially over long distances.

The sports implement tuning system 10 and method takes a sports implement, which may be a new sports implement a sports implement in an un-tuned condition, or a sports implement the user desires to retune, and tunes the sports implement specifically to the user of the sports implement tuning system 10. The sports implement tuning system 10 thereby neutralizes any the manufacturing tolerances present and makes a recommendation for tuning the sports implement in a manner that best benefits the user based on how the user uses a particular sports implement. The sports implement tuning system 10 and method (whether automated or manual) measures the lie and loft of the sports implement and provides feedback to the operator, the fitter, or the automated fitting machine in communication with the sports implement tuning system 10 that will allow for a memory of the sports implement being adjusted to be learned. The sports implement tuning system 10 will measure each of the sports implements in an automated system, where the sports implements are measured in both a static state and a dynamic state. FIG. 3B illustrates the exemplary sports implement 60 in a dynamic state.

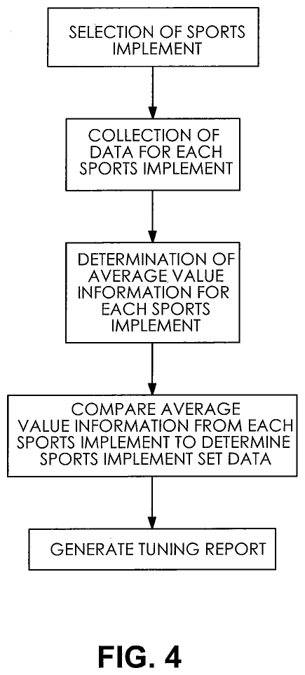

FIG. 4 is a schematic illustration of the process used to generate a tuning report used with a set of sports implements using the sports implement tuning system 10 and method. The sports implement tuning system 10 and method provides for several methodologies to capturing the data used to generate the tuning report 14 in a session based approach. In one methodology, the sports implement tuning system 10 performs the steps of measuring and saving each of each of the sports implement in the set of sports implements to the sports implement information 40, measuring and saving swing (shot instance) data of each of the sports implement in the set of sports implements to the sports implement information 40, and analyzing both sets of data using the analysis engine 16.

The sports implement tuning system 10 will measure each of the sports implements in an automated system, where the sports implements are measured in the static state. The user or an operator of the sports implement tuning system 10 may follow a series of prompts to facilitate the automated measuring.

The next step in the process is measuring and saving swing (shot instance) data using the object tracking devices 24 for each of the sports implements to the sports implement information 40, where the sports implement is measured in the dynamic state. The sports implement tuning system 10 requires at least two shots for each sports implement to be recorded. In some instances, depending on a repeatability of the user, many shots may be required for the sports implement tuning system 10 to collect enough information about each of the sports implements. Each of these shots must be collected in a statistically neutral indoor or outdoor environment.

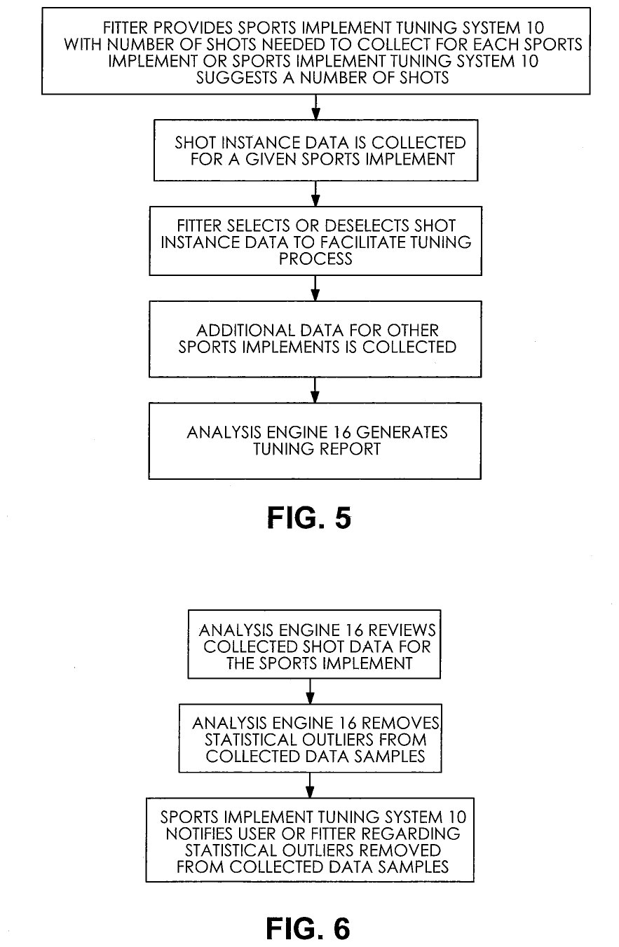

FIG. 5 is a schematic illustration of a process by which the fitter uses the sports implement tuning system 10 to collect data for each of the sports implements. An exact number of shots required may be determined by the fitter. Alternately, it is understood that the sports implement tuning system 10 may be configured to provide suggestions regarding a required number of shots using the analysis engine 16 based on a standard deviation analysis. For each sports implement analyzed, the analysis engine 16 first calculates average values for several values, based on the number of shots taken by the user. It is understood that the analysis engine 16 may modify the information collected to remove statistical anomalies representative of “bad” shots taken by the user. As non-limiting examples, the analysis engine 16 may calculate average values for information such as smash factor, ball velocity, vertical launch angle, horizontal launch angle, backspin, sidespin, rifle spin, total distance, carry distance, ground distance, off line distance, draw fade distance, max height, max height distance, carry time, shot time, three-dimensional co-ordinates of a max height location, three-dimensional co-ordinates of a mid-location, and three-dimensional co-ordinates of an end location.

Next, the average values for each sports implement in the set of sports implement are collected so that comparisons between each sports implement can occur. It is understood that when the sports implements form a set of sports implements, certain performance characteristics of the set gradually change between adjoining sports implements in the set. By analyzing average value differences between the adjoining sports implements using a set of data corresponding to the set of sports implements, the analysis engine 16 facilitates generation of the tuning report 14, which is used in the sports implement tuning process, which may be performed manually or automatically. As non-limiting examples, an average value difference between adjoining sports implements of the set are determined for vertical launch angle, backspin, sidespin, total distance, and carry distance.

Further, additional analysis may be performed on the average values for each sports implement, such as a comparison of vertical launch angle to a manufacturer's specification, an identification of low and high carry distance values, determination of a spread between low and high carry distance values, an identification of max right and max left offline values, determination of a range between max right and max left offline values, and calculation of an average offline distance as a percentage of a maximum offline range distance.

Simultaneously, the sports implement tuning system 10, using the user tracking devices 22, collects biomechanical characteristics of the user while each of the shots are recorded.

The overall objective of measuring and saving swing (shot instance) data is to minimize the memory impact on the data collected by rotating through the sports implements of a set of sports implements in a specified pattern that requires the user to adjust their swing, similar to how the user would participate in the sport conventionally. As a non-limiting example, on a golf course, the user may use a driver first, then followed by an iron, a wedge, a hybrid, a wedge, and so on. The sports implement tuning system 10 does not allow the user to settle in to hitting similar sports implements back to back. For example, using a 9 iron first, then followed by an 8 iron, a 7 iron, and so on. The method collecting swing data can vary and may be modified for specific types of users or for users of differing skill levels, for example, a user having a 26 handicap versus a scratch golfer. As a non-limiting example, an experienced user may be asked to hit or swing one sports implement each time in a random sequence, whereas a beginner player may be allowed to hit several shots with each sports implement at a time, but in the same random sequence.

The sports implement tuning system 10 then allows the fitter to select and deselect shots based on their professional opinion. Further, the sports implement tuning system 10 may be configured to allow the analysis engine 16 to automatically select shots based on a mathematical formula contained in the series of instructions 36 or the reference information 44. Following the selection, the tuning process will then be performed based on the selected shots for each sports implement and/or in relationship to all of the other sports implement that have been measured. It is understood that within the scope of the present invention, that when the sports implement is a portion of the user, the tuning process as described herein may be adapted to provide recommendations to the user regarding a positioning or a path of motion of the sports implement, provide recommendations of an article for the sports implement that can be used to correct or increase the user's performance, or provide recommendations that alter an article used with the sports implement. Further, it is understood that it is within the scope of the present invention for the tuning process described herein below to be implemented by providing recommendations to adjust external factors which may correct or increase the user's performance, such as but not limited to, making adjustments to a shoe of the user.

As mentioned hereinabove, the sports implement tuning system 10 and method provides recommended changes to the lie and loft angles of a given golf sports implement based on the information collected by the sports implement tuning system 10 or the sports simulation equipment 12 and calculations performed by the analysis engine 16. A loft and a lie angle of each sports implement are dynamically measured using high speed video analysis software that allows the measurement of the variables at the closest video frame to impact. The dynamic nature of a sports implement changes based on the speed with which it is swung, due to a flexing of a shaft of the sports implement. The ability to measure the dynamic flex for one or more shots for each sports implement allows the fitter to enter a value or values into the sports implement tuning system 10, which allows a static lie angle and a static loft angle to be compared to the dynamic measurements. This comparison, which takes into account a memory of an individual sports implement, allows for a proper tuning of the static lie and static loft angles to achieve a desired dynamic lie and dynamic loft angles.

The analysis engine 16 will also allow for the adjustment of data based on whether the data collection occurs indoors, outdoors or in both environments. Adjusting the data based on the environment allows the data collected over multiple time periods to be compared to one another. This will allow the analysis engine 16 to modify its findings and produce an “outdoor expected performance” metric. For use with an indoor simulation and launch monitor, such as the sports simulation equipment 12, the analysis engine 16 will allow for a calibrated standard that can be confirmed from environment to environment, which would allow the data to be accurately compared and analyzed.

Data collection by the sports implement tuning system 10 should take place in a statistically neutral range environment. In a statistically neutral range environment, variables such as temperature, environmental conditions (such as wind, rain, grass height, amongst others), data artifacts (for example, a golf ball or balls left on a driving range), are not allowed to impact the user's performance. The range environment should be visually neutral and there should only be a single target present, indicated by a flag, set at a distance appropriate for the average distance associated with the user whose sports implements are being fit. In a simulator environment, the flag would be visible but not three-dimensionally active, which would allow the projectile object to roll through the target rather than contacting it in the simulated environment, which could negatively impact an accuracy of simulated data.

In the simulator environment, the physical environment for the user should also be neutral. As a non-limiting example of a neutral simulator environment, one in which there are no markings present to assist the user in aligning with a target, is preferable.

FIG. 6 is a schematic illustration of a process by which the analysis engine 16 reviews collected shot data for the sports implement. A selection of shots from the collected samples for the sports implement tuning can be done manually (by a fitter or operator) or mathematically using the analysis engine 16. A percentage of shots that are de-selected out of a sample group are also tracked, which provides important information to the user with respect to how a given shot or swing is missed when such a shot or swing occurs.

The sports implement tuning system 10 can also examine a shot or swing history file for each sports implement and each round of data collection, which may be stored in the sports implement information 40 of the storage device 18. This examination determines whether the user, without external feedback, shows an ability to “dial in” their shots. For example, if the user's score is high enough, the software will suggest that the user provide data one shot at a time for each sports implement instead of, for example, ten shots per sports implement at a time.

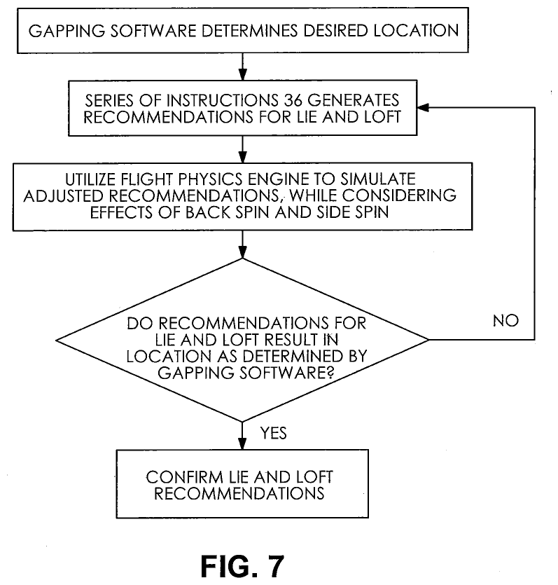

FIG. 7 is a schematic illustration of a process by which the sports implement tuning system 10 utilizes the flight physics engine to makes recommendations for modifications to a lie and loft of the sports implement. The series of instructions 36 which makes recommendations for modifications to lie and loft will utilize the flight physics engine to determine the calculated adjustments necessary to have the projectile object land and/or finish (final location on flat terrain including rolling) at a desired location, as computed by gapping software. Gapping for a set of sports implements refers to the process of tuning the set of sports implements to distribute the performance of the set of sports implements across a performance spectrum preferred by the user. As a non-limiting example, when the set of sports implements is a set of golf clubs, the performance spectrum which the set of golf clubs is distributed across may be shot distance. The goal of gapping a set of golf clubs, therefore, is to tune each club to a preferred shot distance range for the user while minimizing overlap between preceding and successive clubs in the set. Proper gapping for a set of sports implements may be achieved using a proprietary software method that calculates optimal tuning of each of the sports implements (additional information needed here). The flight physics engine, as well as the gapping software, may form a portion of either the sports simulation equipment 12 or the sports implement tuning system 10. When the flight physics engine and the gapping software form a portion of the sports implement tuning system 10, they may be incorporated into the series of instructions 36 or the reference information 44.

The series of instructions 36 includes at least one algorithm that takes into consideration how a back spin and a side spin of the projectile object are impacted by the recommended adjustments in actual projectile object flight outside of the sports simulation equipment 12. The analysis engine 16 accurately predicts those outcomes so that the adjustments take into account the impact of lie and loft angle adjustment to spin rates, based on a projectile object and the sports implement of the user. These metrics are based on the statistical information collected by the sports implement tuning system 10. As non-limiting examples, such statistical information includes at least a back spin, a side spin, a velocity, a horizontal launch angle, and a vertical launch angle.

Based on the results of the analysis, the analysis engine 16 generates the tuning report 14. The tuning report 14 is in a format that can be understood by the operator of the sports implement tuning system 10 or the fitter. As a non-limiting example, the tuning report 14 may include a summary of the analysis performed by the analysis engine 16, data that was excluded from the analysis, and any data that would be considered out of the ordinary. As mentioned hereinabove, it is understood that the tuning report 14 may include all or any portion of the use instance information 46, and that the contents of the tuning report 14 may be customized to include any desired portion of the use instance information.

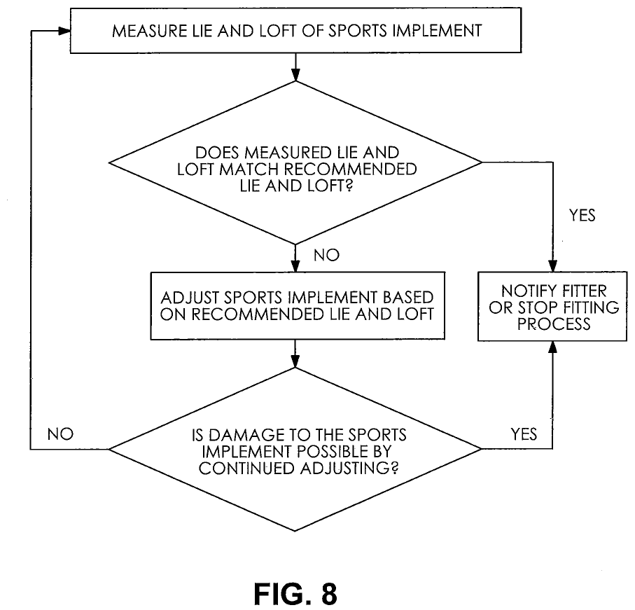

Following the analysis, each of the sports implements, based on the recommendations of the tuning report 14 and the experience of the fitter, has its lie and loft angle adjusted. FIG. 8 is a schematic illustration of a process by which the lie and loft of the sports implement is adjusted using either a manually operated system or an automatically operated system. A manually operated system allows a fitter to receive measurements and feedback from the system as the adjustments are performed, which prevents over-bending of the sports implement and can alarm the fitter of any potential damage to the sports implement. Further, in the event that a given sports implement has been previously adjusted, such a fact would be noted on the tuning report 14, as being aware of a previous tuning can help in minimizing a probability of breaking one of the sports implements by identifying an expected limit for a maximum adjustment based on the initial readings. An automated sports implement adjustment system will measure and bend the sports implement, and repeat the process if necessary until a desired outcome is achieved or the automated system alarms for any potential damage to the sports implement. Each of these systems can also provide measurements regarding a final state of the sports implement before it is returned to the user, which can be reported to the sports implement tuning system 10. The sports implement tuning system 10 can then be used to monitor a given sports implement over time, alarming when the sports implement changes due to normal use or due to the occurrence of a critical event, such as improper grounding of the sports implement or the striking of an object with the sports implement, for example.

The sports implement tuning system 10 approaches the tuning of sports implements in a scientific manner. The sports implement tuning system 10 fits each sports implement of the user's set individually. The sports implement tuning system 10 accepts the user as they are for the tuning purpose of each sports implement. The objective of the method used by the sports implement tuning system 10 is to fit the sports implement to the user instead of tuning the user's swing to the sports implement. The sports implement tuning system 10 takes the user, a given sports implement, and a projectile object preferred by the user as presented, and provides recommendations to adjust a sports implement and a set of sports implements to fix statistical anomalies in the shot or swing distribution data collected and identified by the analysis engine 16, while accounting for variables such as a user's swing speed and acceleration.

The sports implement tuning system 10 and method improves consistency of play for the user, and provides the user with valuable information regarding an expected outcome for a given shot or swing based on their golf swing and a setup associated with each of the sports implements of their set. Further, as the user's game changes or develops over time, or changes are made to the user's set of sports implements, the use of the sports implement tuning system 10 can be repeated to provide up-to-date accuracy and consistency.

The sports implement tuning system 10 and method provides information for tuning sports implements and also provides a verification of results through ongoing data collection. The sports implement tuning system 10 and method generates data for tuning the sports implement from the data set collected by the sports implement tuning system 10. Using the tuning report 14, the fitter then is able to tune the sports implement to the metrics provided by the sports implement tuning system 10 and a verification of the tuning completes the process. The tuning report 14 and the adjusted sports implements then becomes an important tool for the user when engaging in conventional participation of the sport.

The tuning report 14 is able to show a distribution by shot or swing order among the collected samples, thereby showing what a first shot or swing tendency is (if one is present). The distance and offline information can be provided physically on paper or electronically, in the form of the tuning report 14. As a non-limiting example, the tuning report 14 or information present in the tuning report may be accessed by the user through a mobile computing application on a mobile computing device, which the user can access directly when needed. Further, when utilizing a range finder, the user can refer to the tuned information in the tuning report 14 to assist with the sports implement selection process and shot or swing alignment.

The sports implement tuning system 10 can employ a user's sports implement speed to determine a potential the user has with the existing tools. Such information can be generated by simulating a projectile object struck in a near optimal way using the physics engine of the sports implement tuning system 10 at the user's sports implement speed (which is unique to each sports implement) and identifying what a near optimally struck projectile object at such a speed could accomplish. The information associated with such an optimally struck projectile object then identifies a value of practice and improvement to the user for each and every sports implement. The sports implement tuning system 10 can then track any changes that occur to the user's performance over time and also identify when the user needs to re-tune their set of sports implements.

The sports implement tuning system 10 and method accommodates the fact that the tools (such as, but not limited to clubs, balls, and others) employed by the user may change over time and that the user will age and change physically. The sports implement tuning system 10 and method is a process for proper sports implement tuning that adapts over time to the user and allows them to continue to play consistently despite changes that may occur to them personally.

In accordance with the provisions of the patent statutes, the present invention has been described in what is considered to represent its preferred embodiments. However, it should be noted that the invention can be practiced otherwise than as specifically illustrated and described without departing from its spirit or scope.

What is claimed is:

1. A sports implement tuning system comprising:
an analysis engine in communication with a data input source; and
a storage device in communication with the analysis engine, wherein in response to receiving information relating to a shape of the sports implement, the analysis engine accesses the storage device to facilitate an analysis of the shape of the sports implement and the analysis engine generates information relating to a tuning process which may be performed based on the shape of the sports implement and information on the storage device.

2. The sports implement tuning system of claim 1, wherein the sports implement forms a portion of a plurality of sports implements corresponding to a set of sports implements.

3. The sports implement tuning system of claim 1, wherein the data input source is a portion of an arrangement of sports simulation equipment.

4. The sports implement tuning system of claim 1, wherein the data input source is an object tracking device.

5. The sports implement tuning system of claim 1, wherein the information received relating to the shape of the sports implement contains information collected about the sports implement in both a static state and a dynamic state.

6. The sports implement tuning system of claim 5, wherein the information received relating to the shape of the sports implement in a dynamic state contains information about at least two swings of the sports implement.

7. The sports implement tuning system of claim 1, wherein the analysis engine also receives information relating to biomechanical characteristics of the user.

8. The sports implement tuning system of claim 1, wherein the information relating to a tuning process which may be performed includes recommended changes to a lie angle and a loft angle of the sports implement.

9. The sports implement tuning system of claim 1, wherein the analysis engine also receives information relating to an effect of object spin on the information generated relating to the tuning process which may be performed.

10. The sports implement tuning system of claim 1, wherein the analysis engine creates a tuning report based on the information generated relating to the tuning process which may be performed.

11. The sports implement tuning system of claim 1, wherein in response to receiving information relating to a use instance of the sports implement, the analysis engine accesses the storage device to facilitate an analysis of the use instance of the sports implement and the analysis engine generates information relating to a tuning process which may be performed based on the use instance of the sports implement and information on the storage device.

12. The sports implement tuning system of claim 1, wherein the sports implement tuning system is in communication with an automated fitting machine, the automated fitting machine performing the tuning process based on the information relating to the tuning process generated by the analysis engine.

13. The sports implement tuning system of claim 2, wherein the tuning process facilitates a gapping of the set of sports implements, where the gapping distributes the performance of the set of sports implements across a performance spectrum preferred by the user.

14. The sports implement tuning system of claim 1, wherein the tuning process is performed on the sports implement.

15. A tuning system for a set of sports implements comprising:
an analysis engine in communication with a data input source; and
a storage device in communication with the analysis engine, wherein in response to receiving information relating to a shape of each of the sports implements of the set of sports implements and at least one use instance for each of the sports implements of the set of sports implements, the analysis engine accesses the storage device to facilitate an analysis of the information relating to a shape of each of the sports implements of the set of sports implements and the at least one use instance for each of the sports implements of the set of sports implements and the analysis engine generates information relating to a tuning process which may be performed based on the information relating to the shape of each of the sports implements of the set of sports implements, the at least one use instance for each of the sports implements of the set of sports implements, information on the storage device, and statistical anomalies in the collected use instance distribution data.

16. The tuning system for a set of sports implements of claim 15, wherein the data input source is a portion of an arrangement of sports simulation equipment.

17. The tuning system for a set of sports implements of claim 15, wherein the information received relating to the shape of each of the sports implements of the set of sports implements contains information collected about each of the sports implements of the set of sports implements in both a static state and a dynamic state.

18. The tuning system for a set of sports implements of claim 17, wherein the information received relating to the shape of each of the sports implements of the set of sports implements in a dynamic state contains information about at least two use instances of each of the sports implements of the set of sports implements.

19. The tuning system for a set of sports implements of claim 15, wherein the analysis engine also receives information relating to biomechanical characteristics of the user.

20. The tuning system for a set of sports implements of claim 15, wherein the information relating to a tuning process which may be performed on the set of sports implements includes recommended changes to a lie angle and a loft angle for each of the sports implements of the set of sports implements.

21. The tuning system for a set of sports implements of claim 15, wherein the analysis engine also receives information relating to an effect of object spin on the information generated relating to the tuning process which may be performed on the set of sports implements.

22. The tuning system for a set of sports implements of claim 15, wherein the analysis engine creates a tuning report based on the information generated relating to the tuning process which may be performed on the set of sports implements.

23. The tuning system for a set of sports implements of claim 15, wherein the tuning system for a set of sports implements is in communication with an automated fitting machine, the automated fitting machine performing the tuning process based on the information relating to the tuning process generated by the analysis engine.

24. The tuning system for a set of sports implements of claim 15, wherein the tuning process facilitates a gapping of the set of sports implements, where the gapping distributes the performance of the set of sports implements across a performance spectrum preferred by the user.

25. The tuning system for a set of sports implements of claim 15, wherein the tuning process which may be performed on each of the sports implements of the set of sports implements.

26. A method for tuning a sports implement comprising:
providing an analysis engine in communication with a data input source;
providing a storage device in communication with the analysis engine;
receiving information relating to a shape of the sports implement at the analysis engine from the data input source;
accessing the storage device to facilitate an analysis of the information relating to the shape of the sports implement using the analysis engine; and
generating information using the analysis relating to a tuning process which may be performed based on the information relating to the shape of the sports implement and information on the storage device.

27. The method for tuning a sports implement according to claim 26, wherein the data input source is a portion of an arrangement of sports simulation equipment.

28. The method for tuning a sports implement according to claim 26, wherein the step of receiving information relating to the shape of the sports implement contains information collected about the club in both a static state and a dynamic state.

29. The method for tuning a sports implement according to claim 28, wherein the step of receiving information relating to the shape of the sports implement in a dynamic state contains information about at least two use instances of the sports implement.

30. The method for tuning a sports implement according to claim 28, further including the step of receiving information at the analysis engine relating to biomechanical characteristics of the user.

31. The method for tuning a sports implement according to claim 28, wherein the step of generating information using the analysis relating to a tuning process includes recommended changes to a lie angle and a loft angle of the sports implement.

32. The method for tuning a sports implement according to claim 26, further including the step of receiving information at the analysis engine relating to an effect of object spin on the information generated relating to the tuning process which may be performed.

33. The method for tuning a sports implement according to claim 26, further including the step of creating a tuning report using the analysis engine, the tuning report based on the information generated relating to the tuning process which may be performed.

34. The method for tuning a sports implement according to claim 26, wherein the sports implement forms a portion of a plurality of sports implements corresponding to a set of sports implements.

35. The method for tuning a sports implement according to claim 34, wherein the steps of receiving information relating to the shape of the sports implement, accessing the storage device to facilitate an analysis of the information relating to the shape of the sports implement, and generating information using the analysis relating to a tuning process may be repeated for each of the sports implements of the set of sports implements.

36. The method for tuning a sports implement according to claim 26, wherein the steps of receiving information at the analysis engine includes information relating to a use instance of the sports implement, accessing the storage device to facilitate an analysis using the analysis engine includes analyzing information relating to the use characteristic, and generating information using the analysis relating to a tuning process which may be performed is also based on the use characteristic.

37. The method for tuning a sports implement according to claim 26, further including the step of performing the tuning process based on the information relating to the tuning process generated by the analysis engine using an automated fitting machine.

38. The method for tuning a sports implement according to claim 34, further including the step of performing the tuning process based on the information relating to the tuning process generated by the analysis engine using an automated fitting machine, wherein the tuning process facilitates a gapping of the set of sports implements, where the gapping distributes the performance of the set of sports implements across a performance spectrum preferred by the user.

39. The method for tuning a sports implement according to claim 26, wherein the tuning process is performed on the sports implement.
